(19) United States
(12) Patent Application Publication
(10) Pub. No.: US 2025/0340150 A1
(43) Pub. Date: Nov. 6, 2025

(54) IN-MOTION WIRELESS CHARGING SYSTEM FOR ELECTRIC VEHICLE AND CONTROL METHOD THEREOF

(71) Applicant: HYUNDAI MOBIS CO., LTD., Seoul (KR)

(72) Inventor: Joseph DADOUSH, Plymouth, MI (US)

(73) Assignee: HYUNDAI MOBIS CO., LTD., Seoul (KR)

(21) Appl. No.: 18/652,124

(22) Filed: May 1, 2024

(51) Int. Cl. B60L 55/00; B60L 53/126; B60L 53/36; B60L 53/38; B60L 53/57; B60L 53/66

(52) U.S. Cl. CPC B60L 55/00; B60L 53/126; B60L 53/36; B60L 53/38; B60L 53/57; B60L 53/665; B60L 2240/622; B60L 2260/54

(57) ABSTRACT

An in-motion wireless charging system and a method therefor are provided. The system includes: a receiver to receive an in-motion wireless charging request signal including position information from a target vehicle; a controller to control movement of a wireless charging vehicle in relation to a position of the target vehicle by using the position information of the target vehicle, and perform an inter-vehicle link with the target vehicle to match a dynamic driving task (DDT) of the wireless charging vehicle with the target vehicle in the position of the target vehicle; and a charger positioned in the wireless charging vehicle and to wirelessly charge a battery of the target vehicle.

### BACKGROUND

### 1. Field

The present disclosure relates to an in-motion wireless charging system and a control method thereof, and more particularly, to an in-motion wireless charging system that may perform inter-vehicle wireless charging on an in-motion target vehicle and a control method thereof.

### 2. Description of Related Art

As the spread of electric vehicles becomes more popular, interest in electric vehicle charging is also increasing. In the current electric vehicle charging system, an electric vehicle is connected to a separate charging station or a dedicated charging plug that is provided at home or in a parking lot to perform charging.

However, charging an electric vehicle not only takes a lot of time to fully charge compared to regular refueling, but also makes charging difficult because a sufficient charging station is not secured.

Accordingly, recently, interest in wireless charging for electric vehicles has been increasing as an alternative to existing charging stations.

Electric vehicle wireless charging according to a conventional embodiment is a method of charging a vehicle battery by delivering electrical energy to a wireless charging receiving pad of the vehicle through magnetic resonance induction when the vehicle equipped with a wireless charging receiving pad is positioned on a wireless power transmitting pad buried in the ground and current is applied to the wireless power transmitting pad. This electric vehicle wireless charging method has no spatial limitations compared to a traditional plug-based charging method.

However, when wireless charging is performed while waiting at a signal at an intersection, wireless power transmission pads, the number of which corresponds to the number of electric vehicles that wait at the signal at the intersection, have to be buried in the road surface, and when many wireless power transmission pads are buried in the road surface, maintenance is difficult.

### SUMMARY

The present disclosure has been made to solve the above-mentioned problems occurring in the prior art while advantages achieved by the prior art are maintained intact.

An aspect of the present disclosure provides an in-motion wireless charging system that may perform inter-vehicle wireless charging on an in-motion target vehicle, and a control method thereof.

An aspect of the present disclosure also provides an in-motion wireless charging system that performs wireless charging of an in-motion target vehicle to allow the target vehicle to safely travel to a desired destination or a next charging station, and a control method thereof.

The technical problems to be solved by the present disclosure are not limited to the aforementioned problems, and any other technical problems not mentioned herein will be clearly understood from the following description by those skilled in the art to which the present disclosure pertains.

In a general aspect of the disclosure, an in-motion wireless charging system includes: a receiver configured to receive an in-motion wireless charging request signal including position information from a target vehicle; a controller configured to control movement of a wireless charging vehicle in relation to a position of the target vehicle by using the position information of the target vehicle, and perform an inter-vehicle link with the target vehicle to match a dynamic driving task (DDT) of the wireless charging vehicle with the target vehicle in the position of the target vehicle; and a charger positioned in the wireless charging vehicle and configured to wirelessly charge a battery of the target vehicle.

The wireless charging request signal may further include at least one of route information of the target vehicle and a state-of-charge (SoC) of the battery of the target vehicle, and the controller may be configured to perform the inter-vehicle link with the target vehicle through a vehicle-to-everything (V2X) communication.

The controller may be further configured to control the movement to the position of the target vehicle when costs for wireless charging of the target vehicle are paid by a driver of the target vehicle.

The controller may be further configured to: calculate a distance to at least one of a destination of the target vehicle or a next charging station by using the route information; and control the wireless charging of the battery by using the calculated distance and the state-of-charge of the battery.

The controller may be further configured to perform the inter-vehicle link with the target vehicle to match at least one of a speed, braking, and steering with the target vehicle.

The controller may be further configured to synchronize the movement of the wireless charging vehicle and the target vehicle during wireless charging of the target vehicle.

At least one of a receiver coil of the target vehicle and a wireless charger of the wireless charging vehicle may be configured to be movable toward the other to reduce a distance therebetween.

In another general aspect of the disclosure, an in-motion wireless charging control method includes: receiving an in-motion wireless charging request signal including position information from a target vehicle; controlling movement of a wireless charging vehicle in relation to a position of the target vehicle by using the position information of the target vehicle; performing an inter-vehicle link with the target vehicle to match a dynamic driving task (DDT) of the wireless charging vehicle with the target vehicle in the position of the target vehicle; and wirelessly charging a battery of the target vehicle by a charger positioned in the wireless charging vehicle.

The wireless charging request signal may further include at least one of route information of the target vehicle and a state-of-charge (SoC) of the battery of the target vehicle, and the performing of the inter-vehicle link may include performing the inter-vehicle link with the target vehicle through a V2X communication.

The controlling of the movement to the position of the target vehicle may include controlling the movement to the position of the target vehicle when costs for wireless charging of the target vehicle are paid by a driver of the target vehicle.

The charging of the battery of the target vehicle may include: calculating a distance to at least one of a destination of the target vehicle or a next charging station by using the route information; and controlling the wireless charging of the battery by using the calculated distance and the state-of-charge of the battery.

The performing of the inter-vehicle link may include performing the inter-vehicle link with the target vehicle to match at least one of a speed, braking, and steering with the target vehicle.

The in-motion wireless charging control method may further include synchronizing the movement of the wireless charging vehicle and the target vehicle during wireless charging of the target vehicle.

The in-motion wireless charging control method may further include moving at least one of a receiver coil of the target vehicle and a wireless charger of the wireless charging vehicle toward the other to reduce a distance therebetween.

In yet another general aspect of the disclosure, a wireless charging vehicle includes: a receiver configured to receive an in-motion wireless charging request signal including position information from a target vehicle; and a controller configured to: control a movement of the wireless charging vehicle in relation to a position of the target vehicle by using the position information of the target vehicle; perform an inter-vehicle link with the target vehicle to match a dynamic driving task (DDT) of the wireless charging vehicle with the target vehicle in the position of the target vehicle; and control a charger positioned in the wireless charging vehicle to wirelessly charge a battery of the target vehicle.

The features briefly summarized above with respect to the present disclosure are only exemplary aspects of the detailed description of the present disclosure described below, and do not limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an exemplary view for a target vehicle and a wireless charging vehicle;

FIG. 2 illustrates a configuration of an in-motion wireless charging system according to an embodiment of the present disclosure;

FIG. 3 illustrates an exemplary view illustrating a process of wirelessly charging a battery of a target vehicle in a wireless charging vehicle;

FIG. 4 illustrates an operation flowchart for an in-motion wireless charging control method according to another embodiment of the present disclosure; and

FIG. 5 illustrates a block diagram of a computing system for executing an in-motion wireless charging control method according to another embodiment of the present disclosure.

### DETAILED DESCRIPTION

Hereinafter, with reference to the attached drawings, embodiments of the present disclosure will be described in detail so that those skilled in the art may easily perform the present disclosure. However, the present disclosure may be implemented in several different forms and is not limited to the embodiments described herein.

In describing the embodiments of the present disclosure, when it is determined that a detailed description of related known configurations and functions may hinder understanding of the embodiments of the present disclosure, a detailed description thereof will be omitted. In addition, in the drawings, parts that are not related to the description of the present disclosure are omitted, and similar parts are given similar reference numbers.

In the present disclosure, when a component is said to be “connected,” “coupled,” or “connected” to another component, this is not only a direct connection, but also an indirect connection, in which another component exists in therebetween. In addition, when a component is said to “include” or “have” another component, this does not mean excluding the other component, but may further include another component, unless specifically stated to the contrary.

In the present disclosure, terms, such as first and second, are used only for the purpose of distinguishing one component from another component, and do not limit the order or importance of the components unless specifically mentioned. Accordingly, within the scope of the present disclosure, the first component in one embodiment may be referred to as the second component in another embodiment, and similarly, the second component in one embodiment may be referred to as the first component in another embodiment.

In the present disclosure, distinct components are only intended to clearly explain each feature, and do not necessarily mean that the components are separated. That is, a plurality of components may be integrated to form one hardware or software unit, or one component may be distributed to form a plurality of hardware or software units. Therefore, even if not specifically mentioned, such integrated or distributed embodiments are also included in the scope of the present disclosure.

In the present disclosure, the components described in various embodiments do not necessarily mean essential components, and some may be optional components. Accordingly, an embodiment consisting of a subset of the components described in one embodiment is also included in the scope of the present disclosure. In addition, embodiments that include other components in addition to those described in various embodiments are also included in the scope of the present disclosure.

In the present disclosure, expressions of positional relationships used in this specification, such as top, bottom, left, right, etc., are described for convenience of explanation, and when the drawings shown in this specification are viewed in reverse, the positions described in the specification may also be interpreted the other way around.

In the present disclosure, “A or B”, “at least one of A and B”, “at least one of A or B”, “A, B or C”, “at least one of A, B and C”, and each of phrases such as “at least one of A, B, or C” may include any one of the items listed together in that phrase, or any possible combination thereof.

A gist of embodiments of the present disclosure is to control an in-motion target vehicle to perform wireless charging by using a wireless charging vehicle to charge a battery of the target vehicle, and through this, to allow the target vehicle to safely travel to a desired destination or a next charging station.

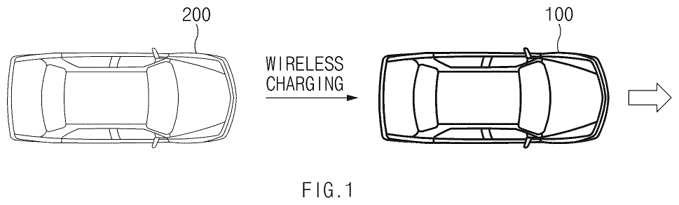

FIG. 1 illustrates an example of a target vehicle and a wireless charging vehicle, and, as illustrated in FIG. 1, may include a target vehicle 100 that requires wireless charging, that is, a target electric vehicle, and a wireless charging vehicle 200 for wirelessly charging a battery of the target vehicle.

According to an embodiment, when a server for providing an in-motion wireless charging service according to an embodiment of the present disclosure, the system of the present disclosure may further include a service server. In the detailed description of the technology of the present disclosure, a service server is omitted, but when a service server is provided, data transmission or reception between the target vehicle and the wireless charging vehicle may be performed through the service server.

The target vehicle 100 may include a signal receiving coil for wireless charging for wirelessly communicating with the wireless charging vehicle 200 to wirelessly receive energy or electric power provided from the wireless charging vehicle 200, and may generate a wireless charging request signal for requesting in-motion wireless charging for the wireless charging vehicle 200 and provide it to the service server or the wireless charging vehicle 200 that may receive a wireless charging request signal. Then, the in-motion wireless charging request signal may include position information (e.g., GPS information) that is received from a GPS provided in the target vehicle 100 and a state-of-charge (SoC) of the battery of the target vehicle, and depending on situations, route information to the destination or destination information may be further included when the destination of the target vehicle is set.

According to an embodiment, the target vehicle 100 may pay a certain amount of money to receive an in-motion wireless charging service. That is, the driver of the target vehicle 100 may transmit an in-motion wireless charging request signal to the wireless charging vehicle by paying a certain amount of money to receive the in-motion wireless charging service. Here, the driver of the target vehicle 100 may pay a certain amount of money through in-vehicle infotainment (IVI).

According to an embodiment, the target vehicle 100 may estimate an arrival time of the wireless charging vehicle based on the position information of the wireless charging vehicle 200 and the position information of the target vehicle, may provide the driver with the estimated arrival time, and when the in-motion wireless charging service is performed by the wireless charging vehicle 200, may provide the driver with the state-of-charge and remaining charging time information of the battery of the target vehicle 100 that is being wirelessly charged through a screen or a head-up display (HUD). Of course, to estimate the arrival time of the wireless charging vehicle, the target vehicle 100 has to receive position information of the wireless charging vehicle to charge the target vehicle, from the wireless charging vehicle.

The wireless charging vehicle 200 is a vehicle for wirelessly charging they battery of the target vehicle 100, and may move to the position of the target vehicle 100 and wirelessly charge the battery of the target vehicle when receiving an in-motion wireless charging request signal from the target vehicle.

According to an embodiment, the wireless charging vehicle 200 may match a dynamic driving task DDT with the target vehicle 100 by moving to the position of the target vehicle 100 and performing an inter-vehicle link with the target vehicle 100 through a vehicle-to-everything (V2X) communication. For example, the wireless charging vehicle 200 may adjust at least one of a speed, braking, and steering of the target vehicle 100 through the inter-vehicle link with the target vehicle 100, and through this, may wirelessly charge the battery of the target vehicle. Of course, the method of wireless charging the battery of the target vehicle 100 in the wireless charging vehicle 200 may vary, and as an example, the wireless charging vehicle 200 may include a wireless battery pack or a wireless charger for charging the battery of the target vehicle 100 by using a vehicle tow hitch receiver, and may be compatible with an on-board bidirectional charger provided in the target vehicle 100 to perform wireless charging. Here, the wireless battery pack or the wireless charger for wireless charging may be attached to an accessory hitch of the wireless charging vehicle 200, and may be safely stored vertically to prevent collision with a bumper of the target vehicle 100, and the wireless battery pack may quickly wirelessly charge the battery of the target vehicle by rotating to a signal receiving coil for wireless charging provided at a lower portion of the target vehicle.

Furthermore, the wireless charging vehicle 200 may release the inter-vehicle link with the target vehicle when the wireless charging for the battery of the target vehicle is completed.

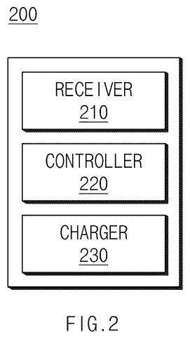

This wireless charging vehicle 200 may include a receiver 210 (e.g., a transceiver), a controller 220 (e.g., oner or more processors), and a charger 230, as illustrated in FIG. 2, and if necessary, various means for controlling in-motion wireless charging may be further included.

The receiver 210 receives an in-motion wireless charging request signal including position information (e.g., GPS information), a state-of-charge (SoC) of the battery of the target vehicle, or route information, from the target vehicle.

According to an embodiment, the receiver 210 may further include payment information for receive a wireless charging service by the target vehicle when an in-motion wireless charging request signal is received. That is, the feature that the wireless charging vehicle receives an in-motion wireless charging request signal from the target vehicle may mean that payment for the wireless charging service has already been performed by the driver of the target vehicle.

The controller 220 controls movement to the position of the target vehicle by using the position information of the target vehicle, and performs an inter-vehicle link with target vehicle, for example, an inter-vehicle link with target vehicle through a V2X communication to match a dynamic driving task (DDT) with the target vehicle in the position of the target vehicle, for example, at least one of a speed, braking and steering with the target vehicle.

Then, the controller 220 may control movement to the position of the target vehicle when the wireless charging vehicle is an unmanned wireless charging vehicle, and when the wireless charging vehicle is a wireless charging vehicle that is moved by the driver, movement to the position of the target vehicle may be controlled through a movement control by the driver and a precise control by the controller.

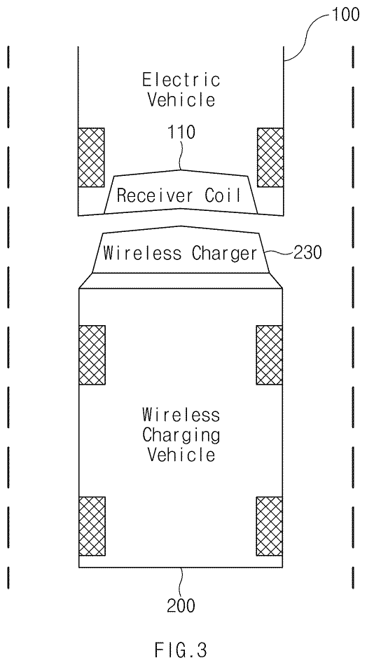

For example, the controller 220, as illustrated in FIG. 3, may match a dynamic driving task (DDT) with the target vehicle through a V2X link with the target vehicle 100 to wirelessly charge the battery of the target vehicle 100 after controlling the movement of the wireless charging vehicle to the position of the target vehicle 100.

The charger 230 controls the wireless charging to wirelessly charge the battery of the target vehicle while the dynamic driving task (DDT) with the target vehicle is matched by the controller 220. Then, the charger 230 may include a wireless charger for controlling wireless charging, as in the example illustrated in FIG. 3. That is, the battery of the target electric vehicle 100 is charged by the wireless charging vehicle 200 via the receiver coil 110 of the target vehicle 100 and the wireless charger 230 of the wireless charging vehicle 200, as illustrated in FIG. 3. At least one of the receiver coil 110 of the target vehicle 100 and a wireless charger 230 of the wireless charging vehicle 200 may be configured to be movable toward the other to reduce a distance therebetween, to increase charging efficiency.

According to an embodiment, the charger 230 may calculate a distance to at least one of a destination or a next charging station of the target vehicle by using the route information of the target vehicle included in the in-motion wireless charging request signal received by the receiver 210, and may control wireless charging of the battery by using the calculated distance and the state-of-charge (SoC) of the battery of the target vehicle.

Then, when wireless charging is controlled based on the distance from the charger 230 to the at least one of the destination of target vehicle or the next charging station, payment for the in-motion wireless charging service may be performed based on the distance from the target vehicle to the destination or the next charging station.

The wireless charging system, such as the wireless charging vehicle 200, according to an embodiment of the present disclosure including the above-described configuration may control the movement to the position of the target vehicle based on the position information of the target vehicle, may match the dynamic driving task (DDT), such as a speed, braking, and steering, with the target vehicle as illustrated in FIG. 3 through the V2X communication with the target vehicle, and may charge the battery of the target vehicle by transmitting electric power or electric energy to the signal receiving coil for wireless charging provided in the target vehicle by using a wireless charger (or a wireless charging battery pack) provided in the wireless charging vehicle. Of course, the target vehicle may charge the battery by using wireless electric power that is received by the signal receiving coil for wireless charging under the control of a battery management system (BMS) that is installed in the target vehicle.

In this way, the in-motion wireless charging system according to an embodiment of the present disclosure may perform wireless charging between vehicles on an in-motion target vehicle by using a wireless charging vehicle.

Furthermore, the in-motion wireless charging system according to an embodiment of the present disclosure may perform wireless charging of the in-motion target vehicle to allow the target vehicle to safely travel to a desired destination or a next charging station.

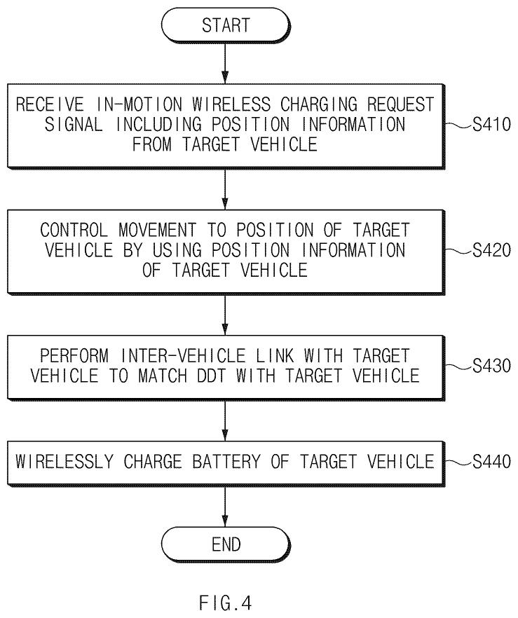

FIG. 4 illustrates an operation flowchart for an in-motion wireless charging control method according to another embodiment of the present disclosure, and illustrates an operation flowchart of the wireless charging vehicle, that is, the in-motion wireless charging system that are disclosed in FIGS. 1 and 2.

Referring to FIG. 4, in the in-motion wireless charging control method according to another embodiment of the present disclosure, an in-motion wireless charging request signal including position information (e.g., GPS information), a state-of-charge (SoC) of the battery of the target vehicle, or route information is received from the target vehicle (S410).

Then, the in-motion wireless charging request signal received through operation S410 may further include payment information for receiving the wireless charging service by the target vehicle.

When the in-motion wireless charging request signal is received in operation S410, the wireless charging vehicle is also moved to the position of the target vehicle by controlling the movement of the wireless charging vehicle based on the position information of the target vehicle included in the in-motion wireless charging request signal (S420).

When the wireless charging vehicle is moved to the position of the target vehicle in operation S420, an inter-vehicle link with the target vehicle, for example, an inter-vehicle link with the target vehicle is performed through V2X communication to match a dynamic driving task (DDT) with the target vehicle in the target vehicle's position, for example, at least one of speed, braking, and steering with the target vehicle (S430).

When the dynamic driving task with the target vehicle is matched in operation S430, the battery of the target vehicle is wirelessly charged by controlling the wireless charger provided in the wireless charging vehicle to wirelessly charge the battery of the target vehicle while the dynamic driving task (DDT) with the target vehicle is matched (S440).

Even though the description is omitted in the method according to other embodiments of the present disclosure, a method according to another embodiment of the present disclosure may include all contents described in the system of FIGS. 1 to 3, and this is obvious to an ordinary person skilled in the art of the present disclosure.

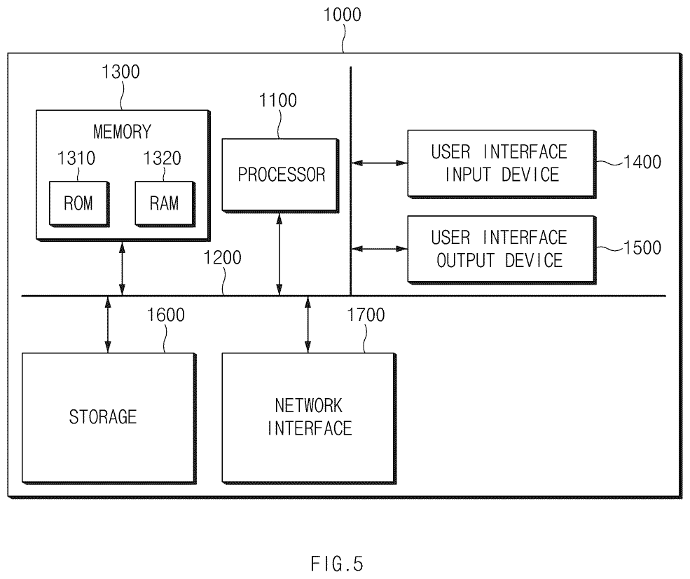

FIG. 5 illustrates a block diagram of a computing system for executing an in-motion wireless charging control method according to another embodiment of the present disclosure.

Referring to FIG. 5, the method for controlling wireless charging according to another embodiment of the present disclosure may be implemented also through the computing system. A computing system 1000 may include at least one of a processor 1100, a memory 1300, a user interface input device 1400, a user interface output device 1500, a storage 1600, and a network interface 1700, which are connected through a system bus 1200.

The processor 1100 may be a central processing unit (CPU), or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the steps of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to the present disclosure, the inter-vehicle wireless charging may be performed on the in-motion target vehicle.

According to the present disclosure, wireless charging of an in-motion target vehicle may allow the target vehicle to safely travel to a desired destination or a next charging station.

The above description is a simple exemplary description of the technical spirits of the present disclosure, and an ordinary person in the art, to which the present disclosure pertains, may make various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. An in-motion wireless charging system comprising:
a receiver configured to receive an in-motion wireless charging request signal including position information from a target vehicle;
a controller configured to:
control movement of a wireless charging vehicle in relation to a position of the target vehicle by using the position information of the target vehicle; and
perform an inter-vehicle link with the target vehicle to match a dynamic driving task (DDT) of the wireless charging vehicle with the target vehicle in the position of the target vehicle; and
a charger positioned in the wireless charging vehicle and configured to wirelessly charge a battery of the target vehicle.

2. The in-motion wireless charging system of claim 1,
wherein the wireless charging request signal further includes at least one of route information of the target vehicle and a state-of-charge (SoC) of the battery of the target vehicle, and
wherein the controller is configured to perform the inter-vehicle link with the target vehicle through a vehicle-to-everything (V2X) communication.

3. The in-motion wireless charging system of claim 1, wherein the controller is further configured to control the movement to the position of the target vehicle when costs for wireless charging of the target vehicle are paid by a driver of the target vehicle.

4. The in-motion wireless charging system of claim 2, wherein the controller is further configured to:
calculate a distance to at least one of a destination of the target vehicle or a next charging station by using the route information; and
control the wireless charging of the battery by using the calculated distance and the state-of-charge of the battery.

5. The in-motion wireless charging system of claim 1, wherein the controller is further configured to perform the inter-vehicle link with the target vehicle to match at least one of a speed, braking, and steering with the target vehicle.

6. The in-motion wireless charging system of claim 5, wherein the controller is further configured to synchronize the movement of the wireless charging vehicle and the target vehicle during wireless charging of the target vehicle.

7. The in-motion wireless charging system of claim 1, wherein at least one of a receiver coil of the target vehicle and a wireless charger of the wireless charging vehicle is configured to be movable toward the other to reduce a distance therebetween.

8. An in-motion wireless charging control method comprising:
receiving an in-motion wireless charging request signal including position information from a target vehicle;
controlling movement of a wireless charging vehicle in relation to a position of the target vehicle by using the position information of the target vehicle;
performing an inter-vehicle link with the target vehicle to match a dynamic driving task (DDT) of the wireless charging vehicle with the target vehicle in the position of the target vehicle; and
wirelessly charging a battery of the target vehicle by a charger positioned in the wireless charging vehicle.

9. The in-motion wireless charging control method of claim 8,
wherein the wireless charging request signal further includes at least one of route information of the target vehicle and a state-of-charge (SoC) of the battery of the target vehicle, and
wherein the performing of the inter-vehicle link includes: performing the inter-vehicle link with the target vehicle through a V2X communication.

10. The in-motion wireless charging control method of claim 8, wherein the controlling of the movement to the position of the target vehicle includes controlling the movement to the position of the target vehicle when costs for wireless charging of the target vehicle are paid by a driver of the target vehicle.

11. The in-motion wireless charging control method of claim 9, wherein the charging of the battery of the target vehicle includes:
calculating a distance to at least one of a destination of the target vehicle or a next charging station by using the route information; and
controlling the wireless charging of the battery by using the calculated distance and the state-of-charge of the battery.

12. The in-motion wireless charging control method of claim 8, wherein the performing of the inter-vehicle link includes performing the inter-vehicle link with the target vehicle to match at least one of a speed, braking, and steering with the target vehicle.

13. The in-motion wireless charging control method of claim 12, further comprising:
synchronizing the movement of the wireless charging vehicle and the target vehicle during wireless charging of the target vehicle.

14. The in-motion wireless charging control method of claim 8, further comprising:
moving at least one of a receiver coil of the target vehicle and a wireless charger of the wireless charging vehicle toward the other to reduce a distance therebetween.

15. A wireless charging vehicle comprising:
a receiver configured to receive an in-motion wireless charging request signal including position information from a target vehicle; and
a controller configured to:
control a movement of the wireless charging vehicle in relation to a position of the target vehicle by using the position information of the target vehicle;
perform an inter-vehicle link with the target vehicle to match a dynamic driving task (DDT) of the wireless charging vehicle with the target vehicle in the position of the target vehicle; and
control a charger positioned in the wireless charging vehicle to wirelessly charge a battery of the target vehicle.
